(19) United States
(12) Patent Application Publication
(10) Pub. No.: US 2007/0184770 A1
(43) Pub. Date: Aug. 9, 2007

(54) Duct apparatus

(75) Inventors: Minoru Shibata, Aichi-ken (JP); Nobuhiro Terai, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/598,641

(22) Filed: Nov. 14, 2006

(30) Foreign Application Priority Data
Dec. 2, 2005 (JP) 2005-349519

(51) Int. Cl. B60H 1/00

(52) U.S. Cl. 454/69

(57) ABSTRACT

A duct apparatus which is connected to an air conditioner and has therein a tubular duct through which conditioned air circulates, includes: an opening portion provided in the duct which extends along a flowing direction of the conditioned air which flows in, the opening portion being provided in such a manner as to extend along the flowing direction of the conditioned air; and a plate-shaped air guiding portion for covering the opening portion, wherein the air guiding portion has a plate thickness of 1.0 mm or more, and has a plurality of air guiding holes allowing an interior of the duct to communicate with an outside and arranged along the flowing direction of the conditioned air.

### BACKGROUND OF THE INVENTION

1. Field of the Invention

The present invention relates to a duct apparatus connected to an air conditioner disposed in, for example, a motor vehicle to supply conditioned air into a passenger compartment.

2. Related Art

Various duct apparatuses are known which are each connected to an air conditioner disposed in a motor vehicle to supply conditioned air to a passenger compartment (e.g., refer to JP-A-2004-203336). The duct apparatus introduced in JP-A-2004-203336 constitutes an armrest of a console box. One end of the duct apparatus is connected to the air conditioner through a connection duct. A plurality of air guiding holes which are constituted by through holes are formed in the other end of the duct apparatus. The conditioned air, which flowed out from the air conditioner and flowed into the duct apparatus through the connection duct, is circulated through the interior of the duct apparatus, and flows to outside the duct, i.e., into the passenger compartment, through the air guiding holes.

In recent years, attempts have been made to guide the airflow direction of the conditioned air in a direction in which it does not impart discomfort to a vehicle occupant, so as to make the passenger compartment of the vehicle into a more comfortable environment for the vehicle occupant. For example, if the conditioned air is blown out directly toward the head or the chest of the vehicle occupant, there are cases where the vehicle occupant feels discomfort. In contrast, if the conditioned air is blown out toward the thighs and their vicinities of the vehicle occupant, it is possible to alleviate the discomfort which is imparted to the vehicle occupant. If the air guiding holes of the duct apparatus such as the one described above are provided in a side wall or a door of the console box, it is conceivably possible to allow the conditioned air to be blown out toward the thighs and their vicinities of the vehicle occupant seated in the driver's seat or passenger's seat (hereafter, this vehicle occupant will be simply referred to as the occupant). However, in this type of duct apparatus, it is difficult to control the direction in which the conditioned air flows out from the duct apparatus to the outside (hereafter, this flowing direction will be referred to as the airflow direction of the conditioned air), and it is difficult to guide the airflow direction of the conditioned air, for example, orthogonally to the flowing direction of the conditioned air which flows into the duct apparatus. Accordingly, even if the air guiding holes are provided in the vicinities of the thighs of the occupant, most of the conditioned air flowing out from the air guiding holes is blown out toward a rear seat. Accordingly, it has been very difficult to blow out toward the thighs and their vicinities of the occupant the conditioned air of a volume capable of sufficiently cooling (or warming) the occupant.

Furthermore, to sufficiently cool (or warm) the occupant's body, it is preferable to blow out the conditioned air toward a plurality of locations along the direction in which the thighs extend, i.e., along the front-and-rear direction. If the above-described duct apparatus is installed in such a manner as to extend in the front-and-rear direction, and a plurality of air guiding holes are provided in the duct apparatus along its extending direction, the conditioned air can conceivably be blow out from the plurality of locations arranged along the direction in which the thighs of the occupant extend. In this case, if the conditioned air is blown out toward the thighs and their vicinities of the occupant at a uniform and gentle airflow velocity, the discomfort which is received by the occupant can conceivably be reduced without causing a part of the occupant's body to be excessively cooled (or excessively warmed). However, in the duct apparatus such as the one introduced in JP-A-2004-203336, the airflow velocity of the conditioned air blown out from the air guiding holes formed on the downstream side in the flow of the conditioned air is very large as compared with the airflow velocity of the conditioned air blown out from the air guiding holes formed on the upstream side in the flow of the conditioned air. Accordingly, it has been difficult to cause the conditioned air to be blown out at a uniform airflow velocity from the plurality of air guiding holes provided along the extending direction of the duct apparatus.

### SUMMARY OF THE INVENTION

The present invention has been devised in view of the above-described circumstances, and its object is to provide a duct apparatus which is capable of guiding the airflow direction of the conditioned air in a desired direction, and of blowing out the conditioned air from the plurality of air guiding holes at a uniform airflow velocity.

The duct apparatus in accordance with the invention for overcoming the above-described problems is a duct apparatus which is connected to an air conditioner and has therein a tubular duct through which conditioned air circulates, comprising: an opening portion provided in the duct which extends along a flowing direction of the conditioned air which flows in, the opening portion being provided in such a manner as to extend along the flowing direction of the conditioned air; and a plate-shaped air guiding portion for covering the opening portion, wherein the air guiding portion has a plate thickness of 1.0 mm or more, and has a plurality of air guiding holes allowing an interior of the duct to communicate with an outside and arranged along the flowing direction of the conditioned air.

The duct apparatus in accordance with the invention should preferably have anyone of the following configurations (1) to (8), and should more preferably have a plurality of the configurations (1) to (8).

(1) The plate thickness of the air guiding portion is 2.0 mm or more.

(2) An area of an opening of each of the air guiding holes is 500 mm² or less.

(3) An area of an opening of each of the air guiding holes is 7.0 mm² or more.

(4) A proportion of the air guiding holes in an outside side surface of the air guiding portion is 10 to 60%.

(5) The proportion of the air guiding holes in the outside side surface of the air guiding portion is 20 to 50%.

(6) The air guiding holes are formed at intervals of 5.0 mm or more.

(7) The shape of an opening of the air guiding hole is a polygon surrounded by four or more line segments.

(8) The shape of the opening of the air guiding hole is circular.

In the duct apparatus in accordance with the invention, the conditioned air which flowed into the interior of the duct from the air conditioner reaches the opening portion after circulating through the interior of the duct. Since the opening portion is covered by the air guiding portion having a plurality of air guiding holes, the conditioned air flows out to the outside through the air guiding holes. Since the duct extends along the flowing direction of the conditioned air flowing into the duct interior (hereafter, this flowing direction will be referred to as the inflow direction of the conditioned air), the turbulent flow of the conditioned air is difficult to occur inside the duct. The air guiding holes extend in the direction perpendicular to the inflow direction of the conditioned air, and partition the opening portion into small regions. For this reason, the airflow direction of the conditioned air can be guided with high accuracy along the extending direction of the air guiding holes. Further, in the duct apparatus in accordance with the invention, since the airflow direction of the conditioned air can be guided with high accuracy along the extending direction of the air guiding holes, the airflow velocity of the conditioned air flowing out to the outside from the plurality of air guiding holes arranged along the extending direction of the duct (the inflow direction of the conditioned air) becomes uniform. In addition, since the plate thickness of the air guiding portion is 1.0 mm or more, the depthwise length of the air guiding hole also becomes 1.0 mm or more and is set to a length capable of guiding the airflow direction of the conditioned air. Accordingly, with the duct apparatus in accordance with the invention, the airflow direction of the conditioned air can be guided in a desired direction by the air guiding holes.

In a case where the duct apparatus in accordance with the invention has the above-described configuration (1), the length of the air guiding hole becomes further longer, so that the airflow direction of the conditioned air can be guided reliably in a desired direction.

In a case where the duct apparatus in accordance with the invention has the above-described configuration (2), the airflow direction of the conditioned air can be guided in a more desirable manner. Namely, as the opening area of each of the air guiding holes is set to 500 mm² or less, the opening portion can be partitioned into sufficiently small regions, so that the airflow direction of the conditioned air can be guided with higher accuracy along the extending direction of the air guiding holes.

In a case where the duct apparatus in accordance with the invention has the above-described configuration (3), the airflow direction of the conditioned air can be guided in a more desirable manner. Namely, the smaller the opening area of each of the air guiding holes, the smaller the volume of the conditioned air circulating through each of the air guiding holes. If the opening area of each of the air guiding holes is excessively small, the volume of the conditioned air circulating through each of the air guiding holes also becomes excessively small, and the pressure loss at the time the conditioned air passes through the air guiding holes becomes large. Accordingly, in this case, the airflow direction of the conditioned air becomes difficult to control by the respective air guiding holes. If the opening area of each of the air guiding holes is 7 mm² or more, the volume of the conditioned air circulating through each of the air guiding holes does not become excessively small, and the airflow direction of the conditioned air can be guided in a desired direction by the respective air guiding holes.

In a case where the duct apparatus in accordance with the invention has the above-described configuration (4), the airflow direction of the conditioned air can be guided in a desired direction. If the real opening ratio of the air guiding portion is 10% or more, the volume of the conditioned air flowing out to the outside through the air guiding holes becomes sufficiently large, and the pressure loss acting in the air guiding portion is kept at a sufficiently small level, so that the airflow direction of the conditioned air can be controlled with high accuracy. In addition, the larger the real opening ratio of the air guiding portion, the lower the strength of the air guiding portion; however, if the real opening ratio is 60% or less, the strength of the air guiding portion becomes sufficiently high. Furthermore, if the real opening ratio of the air guiding portion is 60% or less, the opening portion is partitioned into sufficiently small regions by the air guiding holes. Therefore, the airflow direction of the conditioned air can be guided with high accuracy along the extending direction of the air guiding holes.

In a case where the duct apparatus in accordance with the invention has the above-described configuration (5), the airflow direction of the conditioned air is guided more reliably in a desired direction.

In a case where the duct apparatus in accordance with the invention has the above-described configuration (6), the air guiding portion can be provided with sufficient strength, and the airflow direction of the conditioned air can be controlled with higher accuracy. Namely, if the intervals between the air guiding holes are excessively small, the strength of the air guiding portion declines, and there are cases where the conditioned air flowing out from the air guiding holes interferes with the airflow direction of the conditioned air flowing out from the adjacent air guiding holes. If the respective air guiding holes are formed with intervals of 5 mm or more, the air guiding holes can be arranged with sufficient intervals, so that the strength of the air guiding portion becomes sufficiently high, and the conditioned air flowing out from the air guiding holes does not interfere with the airflow direction of the conditioned air flowing out from the adjacent air guiding holes.

In a case where the duct apparatus in accordance with the invention has the above-described configuration (7) or (8), the regions where the conditioned air circulates in the interiors of the air guiding holes can be made sufficiently large. Namely, in the duct apparatus in accordance with the invention, the shape of the opening of the air guiding hole is not limited to a circle and may be a polygon such as a triangle, a rectangle, and a hexagon, or may be another shape. However, as for each of the regions where the conditioned air circulates in the interiors of the air guiding holes, a cross section in a direction perpendicular to the circulating direction of the conditioned air assumes a shape which approximates a circle. Accordingly, if the air guiding holes are of the same size, the closer to a circle the shape of the opening of the air guiding hole (or the greater the number of line segments surrounding a polygon), the regions where the conditioned air circulates in the interiors of the air guiding holes can be made large.

### BRIEF DESCRIPTION OF THE DRAWINGS

FIG. 1 is an exploded perspective view schematically illustrating a duct apparatus in accordance with a first embodiment;

FIG. 2 is a cross-sectional view schematically illustrating a cross section of the duct apparatus of the first embodiment taken along line A-A in FIG. 1;

FIG. 3 is a cross-sectional view schematically illustrating a cross section of the duct apparatus of the first embodiment taken along line B-B in FIG. 1; and

FIG. 4 is a cross-sectional view schematically illustrating a cross section of the duct apparatus of another embodiment taken along at the same position as line B-B in FIG. 1.

### DETAILED DESCRIPTION OF THE PREFERRED EMBODIMENTS

Referring now to the drawings, a description will be given of the duct apparatus in accordance with the invention.

### First Embodiment

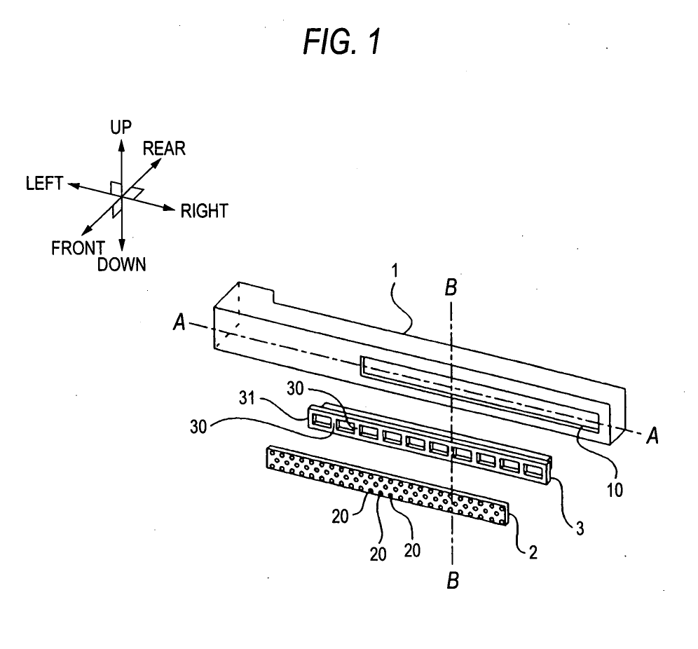

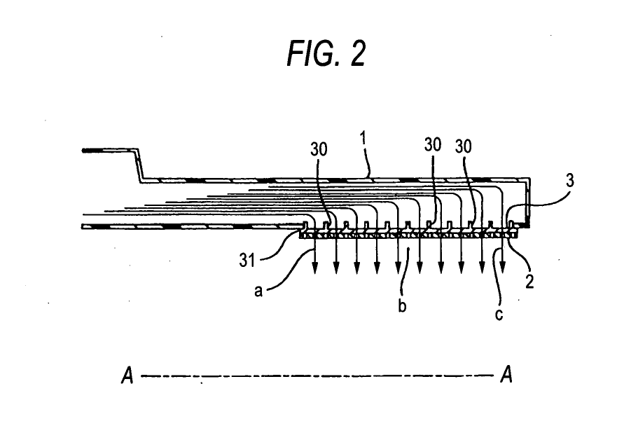

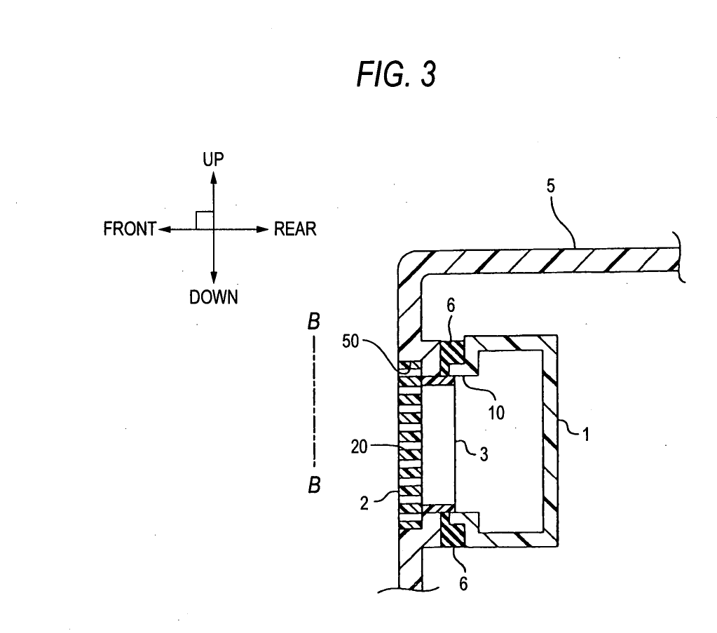

The duct apparatus in accordance with a first embodiment has the above-described configurations (1) to (6) and (8). The duct apparatus in accordance with the first embodiment is installed in a console box of a motor vehicle. An exploded perspective view schematically illustrating the duct apparatus in accordance with the first embodiment is shown in FIG. 1, and a cross-sectional view schematically illustrating a cross section of the duct apparatus of the first embodiment taken along line A-A in FIG. 1 is shown in FIG. 2. A cross-sectional view schematically illustrating a cross section of the duct apparatus of the first embodiment taken along line B-B in FIG. 1 is shown in FIG. 3. Hereafter, the directions associated with the terms “vertical” “left,” “right,” “front,” and “rear” referred to herein shall be construed to be those shown in FIG. 1.

The duct apparatus in accordance with the first embodiment has a duct 1, an air guiding portion 2, and a rectifying member 3. The duct 1 has a substantially rectangular tubular shape, and has one end portion connected to an air conditioner (not shown). The duct 1 extends along the inflow direction of conditioned air indicated by the arrows in FIG. 2. An opening portion 10 is formed at the other end portion of the duct 1. The opening portion 10 extends in the left-and-right direction (the inflow direction of the conditioned air). The opening portion 10 is covered by the air guiding portion 2 which is plate-shaped. The air guiding portion 2 has a plurality of air guiding holes 20 which are arranged at equal intervals in the left-and-right direction (the inflow direction of the conditioned air) and in the vertical direction (a direction perpendicular to the inflow direction of the conditioned air). The air guiding holes 20 extend in the front-and-rear direction (a direction perpendicular to the inflow direction of the conditioned air) and allow the interior of the duct 1 and the outside to communicate with each other. In the duct apparatus in accordance with the first embodiment, the respective air guiding holes 20 extend parallel to each other. The plate thickness of the air guiding portion 2 is 3.0 mm. The respective air guiding holes 20 are formed in the same shape, and the opening of each air guiding hole 20 has the shape of a regular circle. Each air guiding hole 20 has an opening diameter of 5.0 mm and an opening area of 19.63 mm². The air guiding holes 20 are formed at intervals of 7.0 mm and have a real opening ratio of 40.1%.

The rectifying member 3 is disposed between the opening portion 10 and the air guiding portion 2. In the rectifying member 3, a plurality of plate-shaped guide fins 30 extending in the vertical direction (the direction perpendicular to the inflow direction of the conditioned air) are arranged at equal intervals, and the guide fins 30 are secured to the interior of a body portion 31 having a frame shape. The duct 1, the air guiding portion 2, and the rectifying member 3 are respectively formed separately, and are integrated by being secured to each other.

The duct apparatus in accordance with the first embodiment is installed in a console box 5. Specifically, as shown in FIG. 3, a console opening 50 is formed in the console box 5, and the duct 1 is secured to a rear surface side of the console box 5 with the opening portion 10 opposing the console opening 50. Since a seal member 6 formed of an elastic material is secured to a rear side peripheral edge portion of the console opening 50, the duct 1 and a peripheral edge portion of the console opening 50 abut against each other through the seal member 6. The air guiding portion 2 is disposed on the front surface side of the console box 5, is secured to a front side peripheral edge portion of the console opening 50, and covers the opening portion 10 and the console opening 50. The rectifying member 3 is disposed on the rear side of the air guiding portion 2, and a portion thereof is held inside the opening portion 10.

In the duct apparatus in accordance with the first embodiment, the conditioned air which flowed into the duct 1 from the air conditioner circulates through the interior of the duct 1 along the extending direction of the duct 1 (the inflow direction of the conditioned air). The conditioned air, which has circulated through the interior of the duct 1 and reached the opening portion 10, flows out to the outside through the rectifying member 3 and the air guiding portion 2.

In the duct apparatus in accordance with the first embodiment, since the duct 1 extends along the flowing direction of the conditioned air, the turbulent flow of the conditioned air is difficult to occur inside the duct 1. The air guiding holes 20 extend in the direction perpendicular to the inflow direction of the conditioned air, and partition the opening portion 10 into small regions. For this reason, the airflow direction of the conditioned air is guided with high accuracy along the extending direction of the air guiding holes 20. Further, since the airflow direction of the conditioned air is guided with high accuracy along the extending direction of the air guiding holes 20, the airflow velocity of the conditioned air flowing out to the outside from the plurality of air guiding holes 20 arranged along the extending direction of the duct 1 (the inflow direction of the conditioned air) becomes uniform. It should be noted that, in the duct apparatus in accordance with the first embodiment, the conditioned air which reached the opening portion 10 is rectified by the rectifying member 3, and reaches the air guiding portion 2. For this reason, the airflow direction of the conditioned air is guided more reliably in a desired direction.

In the duct apparatus in accordance with the first embodiment, the air guiding portion 2, the duct 1, and the rectifying member 3 are respectively formed separately, but may be formed integrally.

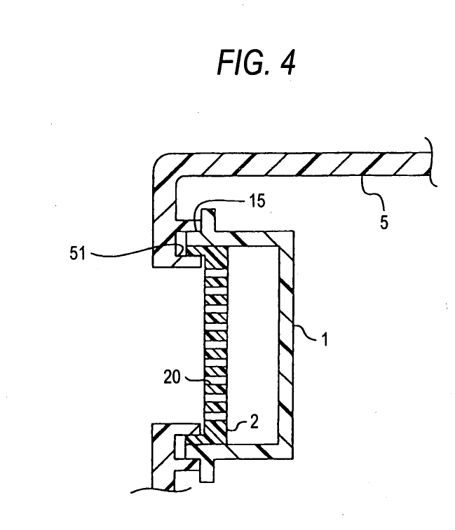

In the duct apparatus in accordance with the first embodiment, the air guiding portion 2 is secured to the front surface side of the console box 5, and the duct 1 is secured to the rear surface side of the console box 5. However, as shown in FIG. 4, the duct 1 and the air guiding portion 2 may be fixed to the same surface (the rear surface in FIG. 4). In this case, if a console-side retaining portion 51 for retaining the duct 1 and the air guiding portion 2 is provided on the console box 5, and a duct-side retaining portion 15 for engaging the console-side retaining portion 51 is provided on the duct 1, the duct 1 and the air guiding portion 2 can be easily attached to the console box 5.

### Second Embodiment

The duct apparatus in accordance with a second embodiment has the above-described configurations (1) to (4), (6), and (8). The duct apparatus in accordance with the second embodiment is identical to the duct apparatus in accordance with the first embodiment except for the shape of the air guiding portion.

The plate thickness of the air guiding portion in the duct apparatus in accordance with the second embodiment is 3.0 mm. The respective air guiding holes are formed in the same shape, and the opening of each air guiding hole has the shape of a regular circle. Each air guiding hole has an opening diameter of 3.0 mm and an opening area of 7.07 mm². The air guiding holes are formed at intervals of 7.0 mm and have a real opening ratio of 14.4%.

In the duct apparatus in accordance with the second embodiment, in the same way as the duct apparatus of the first embodiment, since the duct extends along the flowing direction of the conditioned air, the turbulent flow of the conditioned air is difficult to occur inside the duct. The air guiding holes extend in the direction perpendicular to the inflow direction of the conditioned air, and partition the opening portion into small regions. For this reason, the airflow direction of the conditioned air is guided with high accuracy along the extending direction of the air guiding holes, and the airflow velocity of the conditioned air flowing out to the outside from the plurality of air guiding holes arranged along the extending direction of the duct (the inflow direction of the conditioned air) becomes uniform.

### Third Embodiment

The duct apparatus in accordance with a third embodiment has the above-described configurations (2) to (4), (6), and (8). The duct apparatus in accordance with the third embodiment is also identical to the duct apparatus in accordance with the first embodiment except for the shape of the air guiding portion.

The plate thickness of the air guiding portion in the duct apparatus in accordance with the third embodiment is 1.0 mm. The respective air guiding holes are formed in the same shape, and the opening of each air guiding hole has the shape of a regular circle. Each air guiding hole has an opening diameter of 3.0 mm and an opening area of 7.07 mm². The air guiding holes are formed at intervals of 7.0 mm and have a real opening ratio of 14.4%.

In the duct apparatus in accordance with the third embodiment, in the same way as the duct apparatus of the first embodiment, since the duct extends along the flowing direction of the conditioned air, the turbulent flow of the conditioned air is difficult to occur inside the duct. The air guiding holes extend in the direction perpendicular to the inflow direction of the conditioned air, and partition the opening portion into small regions. For this reason, the airflow direction of the conditioned air is guided with high accuracy along the extending direction of the air guiding holes, and the airflow velocity of the conditioned air flowing out to the outside from the plurality of air guiding holes arranged along the extending direction of the duct (the inflow direction of the conditioned air) becomes uniform.

### COMPARATIVE EXAMPLE

The duct apparatus in accordance with a comparative example is also identical to the duct apparatus in accordance with the first embodiment except for the shape of the air guiding portion.

The plate thickness of the air guiding portion in the comparative example is 10.0 mm. The air guiding holes are formed in the shape of slits extending in the vertical direction (in the direction perpendicular to the inflow direction of the conditioned air), and are arranged along the left-and-right direction (in the inflow direction of the conditioned air). The air guiding holes extend parallel to each other. The respective air guiding holes are formed in the same shape, and the opening of each air guiding hole has a rectangular shape. Each air guiding hole has a vertical length of 20.0 mm and a left-to-right length of 20.0 mm. Each air guiding hole has an opening area of 2000 mm². The air guiding holes are formed at intervals of 2.0 mm and have a real opening ratio of 91%.

In the duct apparatus in accordance with the comparative example, in the same way as the duct apparatus of the first embodiment, since the duct extends along the flowing direction of the conditioned air, the turbulent flow of the conditioned air is difficult to occur inside the duct. The air guiding holes extend in the direction perpendicular to the inflow direction of the conditioned air, and partition the opening portion into small regions. For this reason, the airflow direction of the conditioned air is guided with high accuracy along the extending direction of the air guiding holes, and the airflow velocity of the conditioned air flowing out to the outside from the plurality of air guiding holes arranged along the extending direction of the duct (the inflow direction of the conditioned air) becomes uniform.

(Performance Evaluation Test: Airflow Velocity Measurement Test)

The duct apparatuses in accordance with the first to third embodiments and the comparative example were installed in the air conditioner, and the airflow velocity of the conditioned air flowing out from the duct apparatus was measured. Specifically, the velocities of the conditioned air at three points including an upstreammost side position (position a) in the inflow direction of the conditioned air in the opening portion, a downstreammost side position (position c) in the inflow direction of the conditioned air in the opening portion, and an intermediate position (position b) between the position a and the position c were measured at a position located on the outside opposing the opening portion. An air velocity sensor was used as the measuring apparatus. The distance between the opening portion and the measuring apparatus was 100 mm. The rate of flow of the conditioned air flowing into the duct from the air conditioner was 30 m³/h. The results of the airflow velocity measurement test are shown in Table 1.

(Performance Evaluation Test: Pressure Loss Measurement Test)

The duct apparatuses in accordance with the first to third embodiments and the comparative example were installed in the air conditioner, and the pressure loss at the time when the conditioned air passes through the duct apparatus was measured. The results of the pressure loss measurement test, together with the results of the airflow velocity measurement test, are shown in Table 1.

TABLE 1

| | Airflow Velocity (m/s) | | | Pressure |
|---|---|---|---|---|
| | Position a | Position b | Position c | Loss (Pa) |
| First | 1.3 | 1.5 | 1.6 | 4.4 |
| Embodiment | | | | |
| Second | 1.6 | 1.9 | 2.3 | 18.3 |
| Embodiment | | | | |
| Third | 1.6 | 2.0 | 2.6 | 8.1 |
| Embodiment | | | | |
| Comparative | 0.8 | 1.1 | 1.5 | 2.9 |
| Example | | | | |

As shown in Table 1, in the duct apparatus of the comparative example, the airflow velocity of the conditioned air at the position a was 0.8 m/s, and the volume of the conditioned air flowing out from the upstreammost side position (position a) in the inflow direction of the conditioned air in the opening portion in the opposing direction (in the direction perpendicular to the inflow direction of the conditioned air) is small. Accordingly, it can be seen that, in the duct apparatus of the comparative example, the airflow velocity of the conditioned air flowing out to the outside from the plurality of air guiding holes arranged along the inflow direction of the conditioned air is not uniform.

On the other hand, in the duct apparatuses in accordance with the first to third embodiments, the airflow velocities of the conditioned air at the position a, the position b, and the position c are in the range of 1.0 to 2.5 m/s, and it can be seen that the airflow velocity of the conditioned air flowing out to the outside from the plurality of air guiding holes arranged along the inflow direction of the conditioned air is uniform. Particularly in the duct apparatus in accordance with the first embodiment, the airflow velocities of the conditioned air at the position a, the position b, and the position c are substantially uniform, and are contained in the range of 1.0 to 2.0 m/s. Accordingly, in the case where the duct apparatus of the first embodiment is installed in a motor vehicle, and the conditioned air is blown out toward the thighs and their vicinities of the occupant by the duct apparatus of the first embodiment, it is possible to blow out the conditioned air at a uniform and gentle airflow velocity, thereby making it possible to greatly reduce the discomfort which is received by the occupant. Furthermore, the duct apparatus of the first embodiment has an extremely small pressure loss. Accordingly, according to the duct apparatus of the first embodiment, the airflow direction of the conditioned air can be guided reliably in a desired direction.

What is claimed is:

1. A duct apparatus which is connected to an air conditioner and has therein a tubular duct through which conditioned air circulates, comprising:
an opening portion provided in the duct which extends along a flowing direction of the conditioned air which flows in, the opening portion being provided in such a manner as to extend along the flowing direction of the conditioned air; and
a plate-shaped air guiding portion for covering the opening portion,
wherein the air guiding portion has a plate thickness of 1.0 mm or more, and has a plurality of air guiding holes allowing an interior of the duct to communicate with an outside and arranged along the flowing direction of the conditioned air.

2. The duct apparatus according to claim 1, wherein the plate thickness of the air guiding portion is 2.0 mm or more.

3. The duct apparatus according to claim 1, wherein an area of an opening of each of the air guiding holes is 500 mm² or less.

4. The duct apparatus according to claim 1, wherein an area of an opening of each of the air guiding holes is 7.0 mm² or more.

5. The duct apparatus according to claim 1, wherein a proportion of the air guiding holes in an outside side surface of the air guiding portion is 10 to 60%.

6. The duct apparatus according to claim 5, wherein the proportion of the air guiding holes in the outside side surface of the air guiding portion is 20 to 50%.

7. The duct apparatus according to claim 1, wherein the air guiding holes are formed at intervals of 5.0 mm or more.

8. The duct apparatus according to claim 1, wherein the shape of an opening of the air guiding hole is a polygon surrounded by four or more line segments.

9. The duct apparatus according to claim 1, wherein the shape of an opening of the air guiding hole is circular.
